(19) United States
(12) Patent Application Publication
(10) Pub. No.: US 2003/0210443 A1
(43) Pub. Date: Nov. 13, 2003

(54) Method for fabrication of hologram screen

(76) Inventors: Noritatsu Kawai, Yokkaichi-city (JP); Kenichirou Takada, Kuwana-city (JP)

Correspondence Address: HARNESS, DICKEY & PIERCE, P.L.C., P.O. BOX 828, BLOOMFIELD HILLS, MI, 48303, US

(21) Appl. No.: 10/418,765

(22) Filed: Apr. 18, 2003

(30) Foreign Application Priority Data
Apr. 19, 2002 (JP) 2002-118252
Mar. 14, 2003 (JP) 2003-069061

(51) Int. Cl. G02B 5/32

(52) U.S. Cl. 359/15

(57) ABSTRACT

A method for fabrication of a hologram screen displaying an image by diffracting and scattering image light projected from a slanted direction comprising superposing a first dispersion plate on a photosensitive layer, emitting nondivergent light of the first incident light, from the first dispersion plate side, emitting second incident light from the first dispersion plate side, and causing the rays of divergent light obtained by dispersion and transmission of these through the first dispersion plate to interfere with each other on the photosensitive layer. Due to this, interference fringes are recorded on the photosensitive layer and a hologram screen is fabricated. The incident direction of the first incident light on the photosensitive layer is made to substantially match with the projection direction of the image light relative to the hologram screen. Further, the incident direction of the second incident light on the photosensitive layer is made the approximate front direction.

### BACKGROUND OF THE INVENTION

1. Field of the Invention

The present invention relates to a method for fabrication of a hologram screen for displaying an image by diffracting and scattering image light projected from a slanted direction.

2. Description of the Related Art

As a transmission type screen displaying an image by transmission and dispersion of image light, there is the technology using a light dispersion device disclosed in Japanese Unexamined Patent Publication (Kokai) No. 11-295507.

As the method for fabrication of this transmission type screen, as explained later referring to FIG. 27, there is the method of superposing a dispersion plate on the photosensitive layer and emitting laser light from the dispersion plate side. Due to this, the rays of divergent light obtained by dispersion and transmission through the dispersion plate interfere with each other on the photosensitive layer to expose the layer and form the light dispersion device shown in FIG. 28. This constitutes the transmission type screen.

Further, as a method for fabrication of a hologram screen for displaying an image by diffracting and scattering projected image light, there is the method disclosed in Japanese Unexamined Patent Publication (Kokai) No. 11-102153.

As will be explained later with reference to FIG. 34, the ends of a dispersion plate to be recorded on the photosensitive layer are provided with mirrors projecting out to the photosensitive layer. By emitting divergent light to the dispersion plate from the opposite side from the photosensitive layer, an object light dispersed and passed therethrough and a reference light directly striking the photosensitive layer from a slanted direction are made to interfere with each other on the photosensitive layer to record the dispersion plate.

Here, since the mirrors are arranged as explained above, the object light can be reflected at the mirrors and strike the photosensitive layer. Therefore, the same virtual effect is obtained as when recording a large dispersion plate in a hologram.

When projecting image light from a slanted direction to a transmission type screen obtained by the conventional method for fabrication disclosed in Japanese Unexamined Patent Publication (Kokai) No. 11-295507, as will be explained later with reference to FIG. 28, the problem arises that luminance irregularity at the time of viewing from the approximate front direction becomes greater and the luminance falls.

Further, with the transmission type hologram screen fabricated by the method of FIG. 34 disclosed in Japanese Unexamined Patent Publication (Kokai) No. 11-102153 as well, like with the hologram screen described in Japanese Unexamined Patent Publication (Kokai) No. 11-295507, there was the problem of “image loss”.

### SUMMARY OF THE INVENTION

An object of the present invention is to provide a method for fabrication of a hologram screen with little luminance irregularity of the image, high luminance, and no image loss even if viewing the image from the approximate front direction.

To attain the above object, the present invention provides a method for fabrication of a hologram screen displaying an image by diffracting and scattering image light projected from a slanted direction comprising superposing a first dispersion plate (3) on a photosensitive layer (2), emitting nondivergent light of first incident light (41) from the first dispersion plate (3) side, emitting second incident light (42) from the first dispersion plate (3) side, and causing the rays of divergent light obtained by dispersion and transmission of these through the first dispersion plate (3) to interfere with each other on the photosensitive layer (2). Due to this, interference fringes are recorded on the photosensitive layer (2) and a hologram screen is fabricated. The incident direction of the first incident light (41) relative to the photosensitive layer (2) is made to substantially match with the projection direction of the image light relative to the hologram screen. Further, the incident direction of the second incident light (42) relative to the photosensitive layer (2) is made the approximate front direction.

### BRIEF DESCRIPTION OF THE DRAWINGS

These and other objects and features of the present invention will become clearer from the following description of the preferred embodiments given with reference to the attached drawings, wherein:

FIG. 1 is a view explaining the method for fabrication of a hologram screen in a first embodiment,

FIG. 2 is a view explaining rays of divergent light due to first incident light and second incident light in the first embodiment,

FIG. 3 is a view explaining reproduction from a hologram screen in the first embodiment,

FIG. 4 is a view explaining the method for fabrication of a hologram screen in a second embodiment,

FIG. 5 is a view explaining a dispersion angle in a third embodiment,

FIG. 6 is a graph of the distribution of intensity of divergent light in the third embodiment,

FIG. 7 is a graph of the relationship between the dispersion angle of a first dispersion plate and screen gain of a hologram screen,

FIG. 8 is a graph of the distribution of luminance in the plane of the hologram screen in the third embodiment,

FIG. 9 is a view explaining the measurement position of luminance in the third embodiment,

FIG. 10 is a view of a method of measurement of luminance in the third embodiment,

FIG. 11 is a view explaining a method of measurement of illuminance in the third embodiment,

FIG. 12 is a view explaining the method for fabrication of a hologram screen in a fourth embodiment,

FIG. 13 is a view explaining the method for fabrication of a hologram screen in a fifth embodiment,

FIG. 14 is a view explaining the method for fabrication of a hologram screen in a sixth embodiment,

FIG. 15 is a view explaining the state of reproduction of a hologram screen in a seventh embodiment,

FIG. 16 is a view explaining the method for fabrication of a master hologram in the seventh embodiment,

FIG. 17 is a view explaining the method for fabrication of a divided master hologram Ma in the seventh embodiment,

FIG. 18 is a view explaining the method for fabrication of a divided master hologram Mb in the seventh embodiment,

FIG. 19 is a view explaining the method for fabrication of a divided hologram 1a in the seventh embodiment,

FIG. 20 is a view explaining the measurement position of chromaticity and screen grain in the seventh embodiment,

FIG. 21 is a graph of a chromaticity coordinate system in the seventh embodiment,

FIG. 22 is an enlarged view of part of the chromaticity coordinate system in the seventh embodiment,

FIG. 23 is a view explaining another method for fabrication of a divided master hologram Ma in the seventh embodiment,

FIG. 24 is a view explaining another method for fabrication of a divided master hologram Mb in the seventh embodiment,

FIG. 25 is a view explaining the method for fabrication of a master hologram in an eighth embodiment,

FIG. 26 is a view explaining the method for fabrication of a hologram screen in the eighth embodiment,

FIG. 27 is a view explaining the method for fabrication of a transmission type screen in the related art,

FIG. 28 is a view explaining reproduction from a transmission type screen in the related art,

FIG. 29 is a view explaining luminance irregularity of a transmission type screen in the related art,

FIG. 30 is a view explaining reproduction from a transmission type screen over which a light polarizing hologram is superposed,

FIG. 31 is a view explaining the method for fabrication of another transmission type screen in the related art,

FIG. 32 is a cross-sectional view explaining image loss of another transmission type screen in the related art,

FIG. 33 is a front view explaining image loss of another transmission type screen in the related art, and

FIG. 34 is a view explaining a method for fabrication of another hologram screen in the related art.

### DESCRIPTION OF THE PREFERRED EMBODIMENTS

Before describing the embodiments of the present invention, the related art and the disadvantages therein will be described with reference to the related figures.

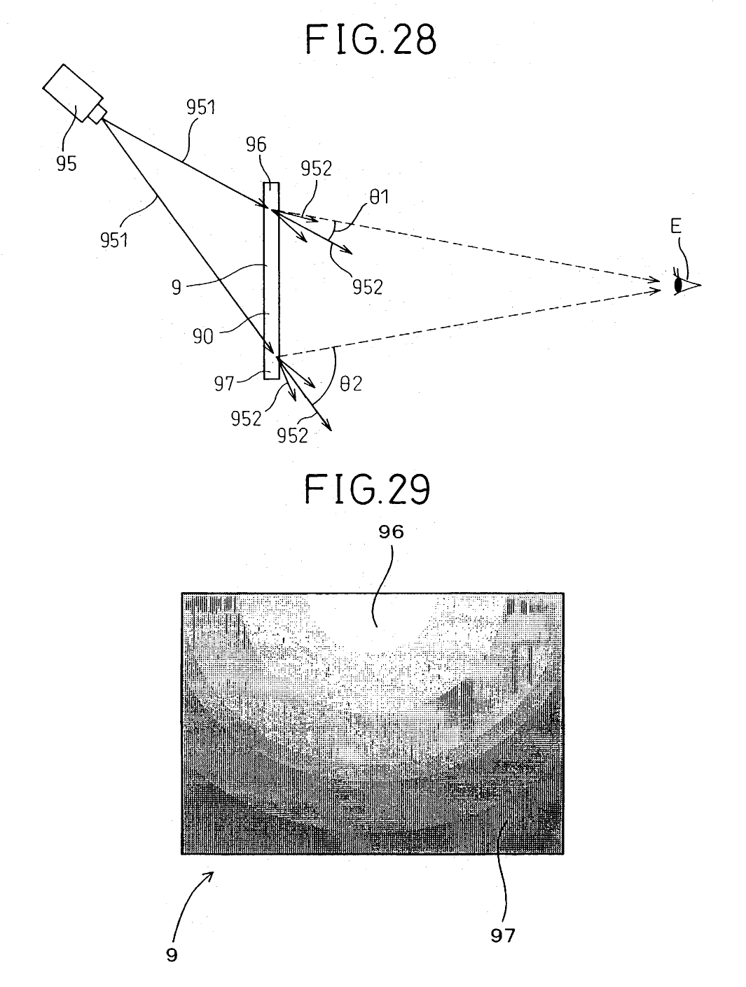

As explained above, as a transmission type screen displaying an image by transmitting and dispersing image light, there is the technology using a light dispersion device disclosed in Japanese Unexamined Patent Publication (Kokai) No. 11-295507. As the method for fabrication of this transmission type screen, as explained later referring to FIG. 27, there is the method of superposing a dispersion plate 93 on a photosensitive layer 92 and emitting laser light 940 from the dispersion plate 93 side. Due to this, the rays of the divergent light 941 dispersing and passing through the dispersion plate 93 interfere with each other on the photosensitive layer 92 to expose the layer 92 and form, as shown in FIG. 28, a light dispersion device 90 constituting the transmission type screen 9.

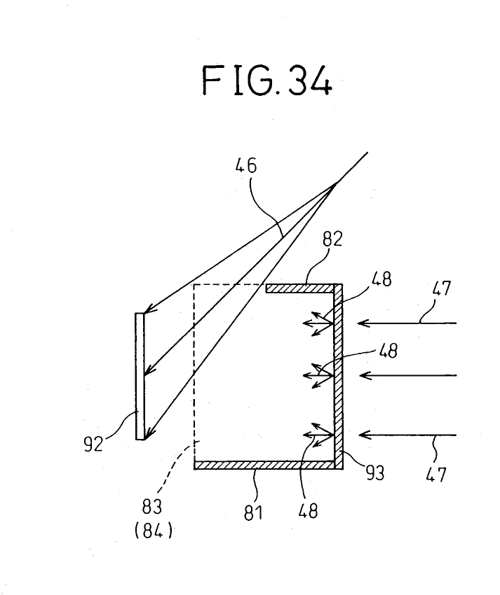

Further, as a method for fabrication of a hologram screen for displaying an image by diffracting and scattering projected image light, there is the method disclosed in Japanese Unexamined Patent Publication (Kokai) No. 11-102153. That is, as shown in FIG. 34, the ends of a dispersion plate 93 to be recorded on the photosensitive layer 92 are provided with mirrors 81, 82, 83, and 84 projecting out to the photosensitive layer 92 side. By emitting divergent light 47 to the dispersion plate 93 from the opposite side from the photosensitive layer 92, an object light 48 dispersed and passed therethrough and a reference light 46 directly striking the photosensitive layer from a slanted direction are made to interfere with each other on the photosensitive layer 92 to record the dispersion plate 93.

Here, since the mirrors 81, 82, 83, and 84 are arranged as explained above, as shown in FIG. 34, the object light 48 can be reflected at the mirrors 81, 82, 83, and 84 and strike the photosensitive layer 92. Therefore, the same virtual effect is obtained as when recording a large dispersion plate on a hologram.

As shown in FIG. 28, however, when projecting image light 951 from a slanted direction to a transmission type screen 9 obtained by the conventional method for fabrication disclosed in Japanese Unexamined Patent Publication (Kokai) No. 11-295507, the problem arises that luminance irregularity at the time of viewing from the approximate front direction becomes greater and the luminance falls (FIG. 29).

For example, as shown in FIG. 28, when emitting image light 951 from above at a slant, the closer to the bottom 97 of the transmission screen 9, the greater the angles θ1 and θ2 formed between the incident direction of the rays of the image light 951 and the line-of-sight direction (approximate front direction) of the observer E. That is, the angle θ2 formed by the incident angle of the image light 951 at the bottom 97 of the transmission type screen 9 and the line-of-sight direction becomes larger than the angle θ1 formed by the incident angle of the image light 951 at the top 96 and the line-of-sight direction.

The light dispersion device 90 forming the transmission type screen 9 by nature increases the intensity of the output light 952 in a direction substantially the same as the incident light to the maximum. Therefore, the larger the angle formed by the incident direction and approximate front direction, the lower the intensity of the output light 952 to the line-of-sight direction of the observer E.

Therefore, the intensity of the output light 952 to the approximate front direction of the transmission type screen 9 falls the closer to the bottom 97 of the transmission type screen 9 and, as shown in FIG. 29, the luminance of the displayed image falls the closer to the bottom 97 of the transmission type screen 9. As a result, luminance irregularity occurs.

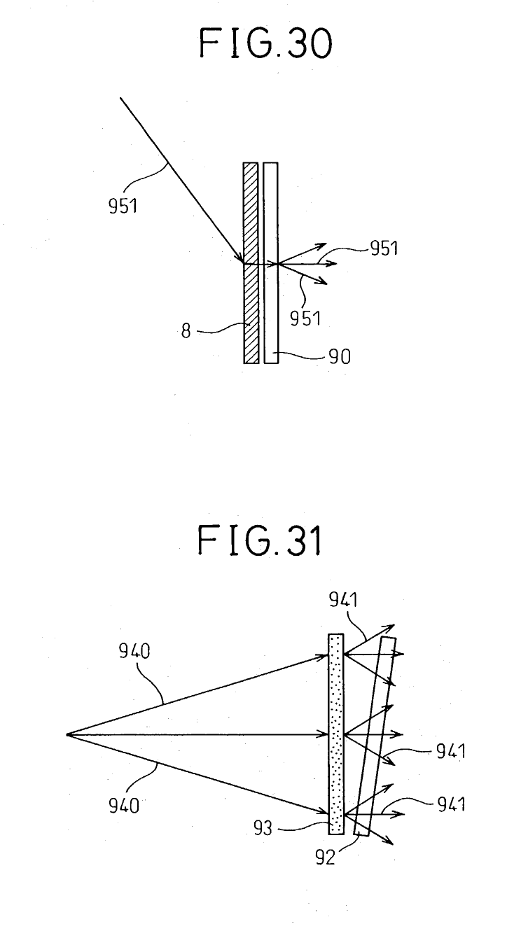

As a measure against this, as shown in FIG. 30, there is the method of superposing a light polarizing hologram 8 on the light dispersion device 90 to change the image light 951 incident at a slant to make it strike the light dispersion device 90 from the front direction. If using this method, however, the image light 951 striking the light polarizing hologram 8 breaks down in color. Due to this, the image of the transmission type screen becomes colored brightly in rainbow colors and the image quality declines.

Further, as shown in FIG. 31, there is the method of exposure while arranging the photosensitive layer 92 at a slant with respect to the dispersion plate 93 corresponding to the projection angle of the image light 951 (FIG. 28). In this method, the direction in which the intensity of the divergent light 941 becomes stronger is inclined relative to the photosensitive layer 92, so even in the fabricated hologram screen, when image light is projected, the direction in which bright diffraction light is obtained is not the front direction of the screen, but the upward or downward direction. Therefore, while it is possible to reduce the luminance irregularity to an observer on the extension of the projection direction of the image light 951, it is not possible to eliminate the luminance irregularity to a front direction observer.

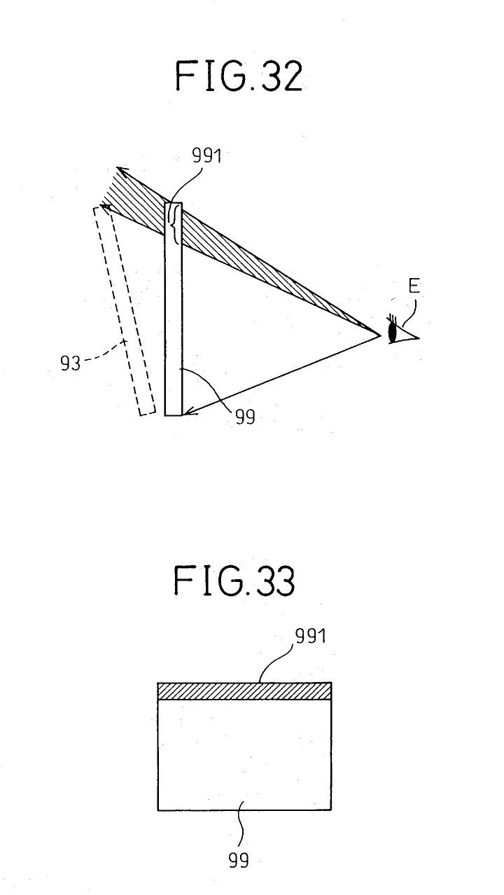

Further, in this case, since the dispersion plate 93 is recorded at a slant in the hologram screen 99, a lost region 991 where the image of the dispersion plate 93 does not appear is formed on the extension of the line of sight of the observer E as shown in FIG. 32. In this lost region 991, scattered light is not diffracted from the hologram screen 99 in the direction of the observer E, so to the observer, it appears as if there is image loss where the image is partially not projected on the hologram screen 99 as shown in FIG. 33.

Further, the transmission type hologram screen fabricated by the method of FIG. 34 disclosed in Japanese Unexamined Patent Publication (Kokai) No. 11-102153 also had the problem of the image appearing to be partially lost in the same way as the hologram screen 9, 99 (FIG. 27 to FIG. 29 and FIG. 33) described in Japanese Unexamined Patent Publication (Kokai) No. 11-295507. The method of Japanese Unexamined Patent Publication (Kokai) No. 11-102153 (FIG. 34) increases the distance to the dispersion plate 93 so as to make the nondivergent light of the reference light 46 strike the photosensitive layer 92. It solves the problem of image loss by arranging mirrors 81 to 84 around the dispersion plate 93 so as to virtually enlarge the dispersion plate 93. However, at the portion which the reference light 46 strikes, the mirror 82 remains short. The problem of image loss therefore could not be completely solved.

Therefore, the present invention provides a method for fabrication of a hologram screen with little luminance irregularity of the image, high luminance, and no image loss even if viewing the image from the approximate front direction. The present invention will be described in detail below.

A first aspect of the present invention is a method for fabrication of a hologram screen for displaying an image by diffracting and scattering image light projected from a slanted direction, comprising superposing a first dispersion plate on a photosensitive layer, emitting nondivergent light of the first incident light from the first dispersion plate side, emitting second incident light from the first dispersion plate side, and causing rays of divergent light obtained by dispersion and transmission of the first incident light and second incident light through the first dispersion plate to interfere on the photosensitive layer so as to record interference fringes on the photosensitive layer and thereby fabricate a hologram screen, at which time, making the incident direction of the first incident light relative to the photosensitive layer substantially match the projection direction of the image light relative to the hologram screen and making the incident direction of the second incident light relative to the photosensitive layer the approximate front direction.

Next, the action and effects of the first aspect of the present invention will be explained. In the method for fabrication of a hologram screen, the first incident light and the second incident light are made to strike the first dispersion plate. The rays of divergent light obtained by the dispersion and transmission of the first incident light and the second incident light through the first dispersion plate become stronger in intensity in the same direction as the incident directions. Therefore, the divergent light in the incident direction of the first incident light and the divergent light of the incident direction of the second incident light strongly interfere with each other on the photosensitive layer. Due to this, the interference fringes recorded on the photosensitive layer can diffract the light striking from substantially the same direction as the first incident light at a high efficiency in substantially the same direction as the second incident light, that is, the approximate front direction.

Here, the incident direction of the first incident light relative to the photosensitive layer is made to substantially match with the projection direction of the image light relative to the hologram screen. Therefore, the image light is diffracted at a high efficiency in the front direction of the hologram screen. The same is substantially true for all parts of the hologram screen. This is because at all parts of the entire surface of the photosensitive layer, the incident direction of the first incident light is made to substantially match with the projection direction of the image light relative to the hologram screen.

That is, the hologram screen displays an image on the entire surface by diffracting and scattering the image light centered on the approximate front direction. Therefore, the hologram screen can provide an image with no luminance irregularity and a high luminance to an observer in the approximate front direction.

Further, in the above method for fabrication of a hologram screen, rays of divergent light obtained by dispersion and transmission of the first incident light and second incident light through the dispersion plate are made to interfere. Therefore, there are a large number of object lights and large number of reference lights striking from a broad range of angles and a large number of interference fringes are recorded. Therefore, even if deviation between the projection direction of the image light and the incident direction of the first incident light becomes relatively large, it is possible to secure color reproducibility of the displayed image.

As explained above, according to the first aspect of the present invention, it is possible to provide a method for fabrication of a hologram screen able to produce a hologram screen with no luminance irregularity and a high luminance.

A second aspect of the present invention is a method for fabrication of a hologram screen for displaying an image by diffracting and scattering image light projected from a slanted direction, comprising successively superposing a photosensitive layer, a first dispersion plate, and a master hologram recording a second dispersion plate, emitting nondivergent light of a reference light from an opposite side of the photosensitive layer relative to the master hologram and making divergent light comprised of the reference light passed through the master hologram and dispersed by the first dispersion plate and divergent light produced by reproduction of the second dispersion plate from the master hologram by the reference light interfere with each other on the photosensitive layer so as to record interference fringes on the photosensitive layer and fabricate the hologram screen, at which time, making the incident direction of the reference light relative to the photosensitive layer substantially match the projection direction of the image light relative to the hologram screen and making the divergent light diffracted and passing through the master hologram disperse and strike the photosensitive layer centered on the approximate front direction.

In the method for fabrication of the hologram screen, the divergent light obtained by the dispersion and transmission of the reference light passing through the master hologram becomes stronger in intensity in the same direction as the incident direction. Further, the divergent light obtained by the dispersion and transmission of the divergent light diffracted at the master hologram becomes stronger in intensity in the same direction as the diffraction direction in the master hologram. Therefore, the divergent light in the incident direction of the reference light and the divergent light in the diffraction direction strongly interfere with each other on the photosensitive layer. Due to this, the interference fringes recorded on the photosensitive layer can diffract the light striking from substantially the same direction as the reference light at a high efficiency in substantially the same direction as the diffraction direction, that is, the approximate front direction.

Here, the incident direction of the reference light relative to the photosensitive layer is made to substantially match with the projection direction of the image light relative to the hologram screen. Therefore, the image light is diffracted at a high efficiency in the front direction of the hologram screen. The same is substantially true for all parts of the hologram screen. This is because at all parts of the entire surface of the photosensitive layer, the incident direction of the reference light is made to substantially match with the projection direction of the image light relative to the hologram screen.

That is, the hologram screen displays an image on the entire surface by diffracting and scattering the image light centered on the approximate front direction. Therefore, the hologram screen can provide an image with no luminance irregularity and a high luminance to an observer in the approximate front direction.

Further, in the above method for fabrication of a hologram screen, the divergent light obtained by dispersion and transmission of the reference light linearly propagating and passing through the master hologram and the divergent light obtained by diffraction and transmission through the first dispersion plate are made to interfere. Therefore, there are a large number of object lights and large number of reference lights striking from a broad range of angles and a large number of interference fringes are recorded. Therefore, even if deviation between the projection direction of the image light and the incident direction of the reference light becomes relatively large, it is possible to secure color reproducibility of the displayed image.

Further, since the light obtained by diffraction and transmission through the master hologram is divergent light produced by reproduction of the second dispersion plate, that divergent light is further dispersed at the first dispersion plate and then strikes the photosensitive layer. As a result, the same effect can be obtained as if the above second dispersion plate which had been further behind the photosensitive layer were provided at the position of the first dispersion plate as a dispersion plate with a dispersion angle larger than the second dispersion plate.

Therefore, the divergent light strikes the photosensitive layer broadened in scatter range, interference fringes diffracting the image light in the line-of-sight direction of the observer at the front are sufficiently recorded over the entire surface of the photosensitive layer, and therefore the luminance irregularity can be further reduced. Also, it is possible to record a dispersion plate of the same size as the photosensitive layer at the position of the first dispersion plate which is contiguous with the photosensitive layer and where there is almost no difference in depth, so it is possible to prevent image loss.

As explained above, according to the second aspect of the present invention, it is possible to provide a method for fabrication of a hologram screen able to produce a hologram screen with little luminance irregularity, high luminance, and no image loss even if viewing the image from the approximate front direction.

A third aspect of the present invention is a method for fabrication of a hologram screen for displaying an image by diffracting and scattering image light projected from a slanted direction, comprising successively superposing a photosensitive layer, a first dispersion plate, and a primary master hologram recording a second dispersion plate, emitting nondivergent light of a reference light to the primary master hologram from an opposite side of the photosensitive layer and making divergent light comprised of the reference light passed through the primary master hologram and dispersed by the first dispersion plate and divergent light produced by reproduction of the second dispersion plate from the primary master hologram by the reference light interfere with each other on the photosensitive layer so as to record interference fringes on the photosensitive layer and fabricate a secondary master hologram, then superposing on the secondary master hologram a photosensitive layer on the surface at the opposite side as the incident surface of the reference light and emit a reference light of the same state as the reference light so as to copy the secondary master hologram and fabricate a hologram screen, at which time, making the incident direction of the reference light relative to the photosensitive layer substantially match the projection direction of the image light relative to the hologram screen and making the divergent light diffracted and passing through the primary master hologram disperse and strike the photosensitive layer centered on the approximate front direction.

In the above method for fabrication of a hologram screen, a hologram similar to the hologram screen obtained by the second aspect of the present invention is obtained as a secondary hologram. Further, by copying the secondary hologram, it is possible to obtain a hologram similar to the secondary hologram, that is, a hologram screen obtained by the second aspect of the present invention. Therefore, it is possible to easily mass produce a hologram screen by this copying.

As explained above, according to the third aspect of the present invention, it is possible to provide a method for fabrication of a hologram screen able to produce a hologram screen with little luminance irregularity, high luminance, and no image loss even if viewing the image from the approximate front direction.

Next, specific embodiments of the present invention will be explained. In the first aspect of the present invention, it is possible to project image light to the hologram screen for example from a slanted angle above or below. Further, the projection angle of the image light to the center of the hologram screen can be made for example about 35°.

Further, the surface of the photosensitive layer which the first incident light and the second incident light strike becomes the surface opposite to the observer at the time of reproduction. Therefore, the “approximate front direction of the photosensitive layer” means the approximate front direction at the opposite side of the hologram screen than the observer. Further, the “approximate front direction” means the approximate front direction relative to the center of the photosensitive layer and means for example a range of about ±5° relative to the normal of the photosensitive layer.

Further, the first incident light can be made to strike a dispersion plate corresponding to the entire surface of the photosensitive layer as divergent light. The first incident light is preferably made higher in intensity than the second incident light. For example, the ratio of intensity of the first incident light and the second incident light (intensity of first incident light/intensity of second incident light) is made about 2 to 8 on the dispersion plate surface. In this case, the interference fringes recorded are increased in efficiency of diffraction of the image light striking from the slanted direction to the approximate front direction.

Further, the second incident light can be made to strike the first dispersion plate as nondivergent light. In this case, it is possible to obtain a hologram screen diffracting the image light in the front direction at an extremely high efficiency.

Further, the second incident light can be made to strike the dispersion plate as divergent light. In this case, the divergent light of the second incident light is further dispersed at the dispersion plate and then strikes the photosensitive layer. Therefore, it strikes the photosensitive layer with a broader scatter range than even the divergent light of the first incident light, interference fringes diffracting the image light in the line-of-sight direction of the observer in the front are sufficiently recorded over the entire surface of the photosensitive layer, and the luminance irregularity can be reduced even further.

Further, preferably the second incident light is divergent light obtained by transmission through a second dispersion plate having a dispersion angle of ±10° to ±60°. In this case, the second incident light strikes the first dispersion plate as divergent light of ±10° to ±60°. Therefore, it is possible to reduce the luminance irregularity while securing the image luminance at the hologram screen. When the dispersion angle is less than ±10°, the efficiency of the interference fringes in diffracting light to the front direction becomes too high and luminance irregularity where the center of the hologram screen becomes bright and the surrounding portions become dark is liable to end up occurring. On the other hand, when the dispersion angle is over ±60°, the intensity of the divergent light becomes too weak and the image luminance at the hologram screen is liable to become too low.

The first dispersion plate preferably has a dispersion angle smaller than the second dispersion plate, particularly preferably a dispersion angle of ±0.5° to ±3°. In this case, it is possible to obtain a hologram screen with little luminance irregularity and a high screen gain, that is, a high image luminance. When the dispersion angle is less than ±0.5°, it is liable to become difficult to eliminate the image loss of the hologram screen. On the other hand, when the dispersion angle is over ±3°, the screen gain of the hologram screen is liable to fall, that is, the image luminance is liable to fall.

Further, the first dispersion plate may also be a hologram recording a dispersion plate. In this case, the intensity of the reference light linear propagating and passing through the first dispersion plate becomes higher, and the transmitted light and the divergent light of the second incident light strongly interfere with each other on the photosensitive layer, so it is possible to strongly record on the photosensitive layer in the hologram screen. Therefore, the luminance when viewed from the approximate front direction becomes higher. Further, since the first dispersion plate is a hologram, interference fringes are formed even by interference between the light diffracted at the first dispersion plate and the second incident light, so the luminance irregularity can also be suppressed. Accordingly, it is possible to obtain a hologram screen with a higher luminance when viewed from the approximate front direction and with little luminance irregularity.

Further, it is possible to emit third incident light from the first dispersion plate side from a direction different from the first incident light and second incident light. In this case as well, it is possible to broaden the scatter range of divergent light by other incident light rather than the divergent light of the first incident light and make it strike the photosensitive layer. Therefore, it is possible to reduce the luminance irregularity even more for similar reasons as with the above [0046].

In the second aspect [0031], preferably the second dispersion plate recorded on the master hologram has a dispersion angle of ±10° to ±60°. In this case, the divergent light generated due to the reproduction of the second dispersion plate from the master hologram by the reference light strikes the first dispersion plate with a dispersion angle of ±10° to ±60°. Therefore, it is possible to reduce the luminance irregularity while securing the image luminance at the hologram screen.

When the dispersion angle is less than ±10°, the efficiency of the interference fringes in diffracting light to the front direction becomes too high and luminance irregularity at the center of the hologram screen becomes bright and the surrounding portions become dark is liable to end up occurring. On the other hand, when the dispersion angle is over ±60°, the intensity of the divergent light becomes too weak and the image luminance at the hologram screen is liable to become too low.

The first dispersion plate is preferably a hologram recording a dispersion plate. In this case, the intensity of the reference light linearly propagating and passing through the first dispersion plate becomes higher, and the transmitted light and the divergent light generated by reproduction of the second dispersion plate from the above master hologram strongly interfere with each other on the photosensitive layer, so it is possible to strongly record on the photosensitive layer in the hologram screen. Therefore, the luminance when viewed from the approximate front direction becomes higher. Further, since the first dispersion plate is a hologram, interference fringes are formed even by interference between the light diffracted at the first dispersion plate and the divergent light from the master hologram, so luminance irregularity can also be suppressed. Accordingly, it is possible to obtain a hologram screen with a higher luminance when viewed from the approximate front direction and with little luminance irregularity.

The master hologram is preferably recorded with a second dispersion plate provided with mirrors substantially perpendicularly at its four sides. In this case, since the second dispersion plate is recorded in the master hologram in a state virtually enlarged, a large dispersion plate is recorded on the photosensitive layer. Therefore, it is possible to obtain a hologram screen with a large view range.

Further, the incident angle of the reference light has a difference with the reference light incident angle when fabricating the master hologram of within ±5°. In this case, a dispersion plate is strongly recorded at the approximate front position on the photosensitive layer. Therefore, it is possible to obtain a hologram screen with a high luminance when viewed from the front direction. When the above angle difference is over ±5°, the reproduction efficiency of the master hologram by the reference light becomes lower, that is, the dispersion plate recorded on the photosensitive layer becomes darker, and the luminance of the hologram screen is liable to fall. Further, since the above angle difference is large, the dispersion plate is liable to be recorded at an offset position and the luminance of the hologram screen when viewed from the front is liable to fall.

Further, preferably the master hologram is comprised of a plurality of divided master holograms, the divided master holograms are individually fabricated by emitting an object light and reference light to the photosensitive layer to expose it, the plurality of divided master holograms are used to individually fabricate a plurality of divided holograms, then the plurality of divided holograms are pieced together so as to have a two-dimensional spread to obtain a hologram screen. In this case, it is possible to easily and inexpensively fabricate a large sized hologram screen. Further, by applying the second aspect of the invention, it is possible to minimize the difference in the color shade and luminance at the seam portions of the plurality of divided holograms.

Next, in the third aspect of the invention, preferably the primary master hologram and secondary master hologram are comprised of pluralities of divided primary master holograms and divided secondary master holograms, the divided primary master holograms are individually fabricated by emitting an object light and reference light to the photosensitive layer to expose it, the plurality of divided primary master holograms are used to individually fabricate a plurality of divided secondary master holograms, the divided secondary master holograms are used to individually reproduce their information on a plurality of divided holograms, then the plurality of divided holograms are pieced together so as to have a two-dimensional spread to obtain a hologram screen. In this case, it is possible to easily and inexpensively fabricate a large sized hologram screen minimizing the difference in the color shade or luminance at the seam portions of the plurality of divided holograms.

### EXAMPLE 1

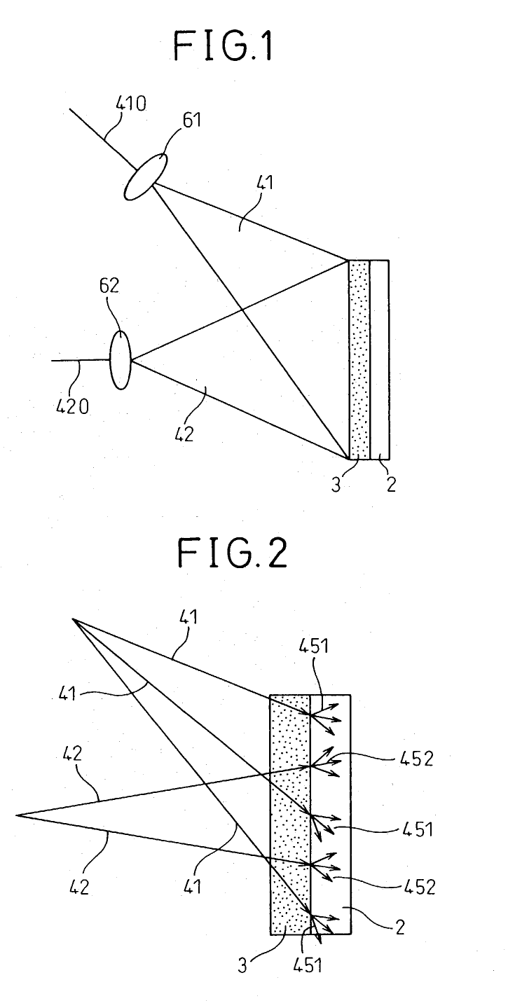

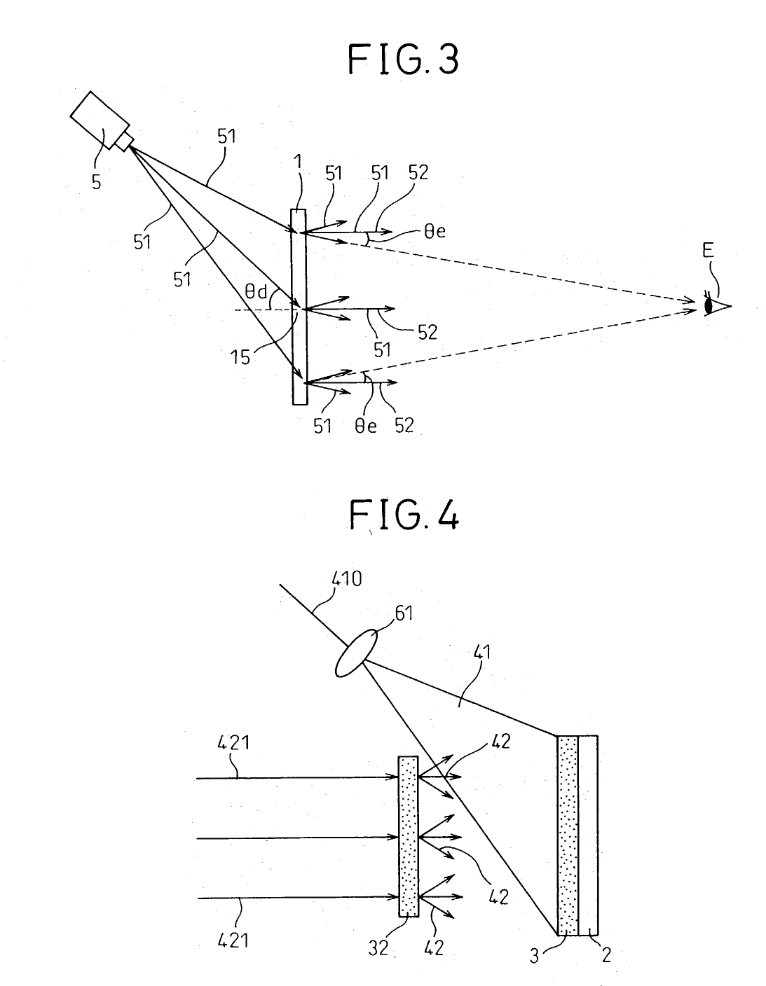

The method for fabrication of a hologram screen according to Example 1 of the present invention will be explained next with reference to FIG. 1 to FIG. 3. The method for fabrication of a hologram screen, as shown in FIG. 3, fabricates a hologram screen 1 displaying an image by diffracting and scattering image light 51 projected from a slanted direction.

In the above method for fabrication of a hologram screen 1, as shown in FIG. 1 and FIG. 2, first the first dispersion plate 3 is stacked on the photosensitive layer 2, the nondivergent light of the first incident light 41 is emitted from the first dispersion plate 3 side, and the second incident light 42 is emitted from the first dispersion plate 3 side. As shown in FIG. 2, the rays of divergent light 451 and 452 obtained by dispersion and transmission of the first incident light 41 and the second incident light 42 through the first dispersion plate 3 interfere with each other on the photosensitive layer 2. Due to this, interference fringes are recorded on the photosensitive layer 2 and the hologram screen 1 is fabricated.

As the photosensitive layer 2, the photopolymer HRF600X made by Dupont was used. As the first dispersion plate 3, a sheet of #1000 single-surface frosted glass of a size of 200×250 mm was used. As the first incident light 41 and second incident light 42, an argon laser of a wavelength of 514 nm was used to emit laser light of an energy of 30 mJ/cm².

As shown in FIG. 1 and FIG. 3, the incident direction of the first incident light 41 relative to the photosensitive layer 2 was made substantially the same as the projection direction of the image light 51 relative to the hologram screen 1. As shown in FIG. 1, the incident direction of the second incident light 42 relative to the photosensitive layer 2 is made the approximate front direction.

As shown in FIG. 3, the image light 51 is projected to the hologram screen 1 from above at a slant. Further, the projection angle θd of the image light 51 to the center 15 of the hologram screen 1 is made about 35°. The image light 51 is projected by a projector 5 arranged above the hologram screen 1 at the opposite side to the observer E.

Further, as shown in FIG. 1, the first incident light 41 and second incident light 42 can be emitted as divergent light to the first dispersion plate 3 corresponding to the entire surface of the photosensitive layer 2. The second incident light 42 is emitted as nondivergent light to the first dispersion plate 3. The first incident light 41 is obtained by emitting laser light 410 to the objective lens 61 arranged at a slant relative to the first dispersion plate 3 so as to form divergent light. Further, the second incident light 42 is obtained by emitting laser light 420 to the objective lens 62 arranged in the front direction relative to the first dispersion plate 3 so as to form divergent light.

The first incident light 42, as shown in FIG. 2, is made the same in incident angle relative to the photosensitive layer 2 as the incident angle θd (FIG. 3) relative to the hologram screen 1 of the image light 51. That is, as shown in FIG. 1, the position of the objective lens 61 relative to the photosensitive layer 2 is substantially the same in positional relationship as the position of the projector 5 relative to the hologram screen 1 (FIG. 3). Further, the first incident light 41 is made higher in intensity than the second incident light 42. Specifically, the ratio of intensity of the first incident light 41 and the second incident light 42 (intensity of first incident light 41/intensity of second incident light 42) was made about 4 on the plane of the first dispersion plate 3.

Next, the actions and effects of Example 1 will be explained. In the above method for fabrication of a hologram screen, the first incident light 41 and second incident light 42 were emitted to the first dispersion plate 3. As shown in FIG. 2, the rays of divergent light 451 and 452 obtained by the dispersion and transmission of the first incident light 41 and second incident light 42 through the first dispersion plate 3 become stronger in intensity in the same direction as the incident directions. Therefore, the divergent light 451 in the incident direction of the first incident light 41 and the divergent light 452 in the incident direction of the second incident light 42 strongly interfere with each other on the photosensitive layer 2. Due to this, the interference fringes recorded on the photosensitive layer 2 can diffract the light incident from substantially the same direction as the first incident light 41 at a high efficiency in substantially the same direction as the second incident light 42, that is, the approximate front direction.

Here, the incident direction of the first incident light 41 relative to the photosensitive layer 2 is made to substantially match the projection direction of the image light 51 relative to the hologram screen 1. Therefore, as shown in FIG. 3, the image light 51 is diffracted at a high efficiency in the front direction of the hologram screen 1.

The same is substantially true for any other part of the hologram screen 1 as a whole. This is because at any part on the surface of the photosensitive layer 2, the incident direction of the first incident light 41 is made to substantially match the projection direction of the image light 51 relative to the hologram screen 1.

That is, as shown in FIG. 3, the hologram screen 1 displays an image over the entire surface by diffracting and scattering image light 51 centered on the approximate front direction. Therefore, for the image light 51 diffracted and scattered at any part of the hologram screen 1, the image light 51 having a small angle θe with the optical axis 52 in that image light 51 heads toward the observer E in the front. This image light 51 has a sufficient intensity. Therefore, the hologram screen 1 can provide an image with little luminance irregularity and a high luminance to an observer E in the approximate front direction.

Further, as shown in FIG. 2, in the method for fabrication of a hologram screen, the divergent lights 451 and 452 obtained by dispersion and transmission of the first incident light 41 and second incident light 42 through the first dispersion plate 3 are made to interfere with each other. Therefore, there are a large number of object lights and large number of reference lights striking from a broad range of angles and a large number of interference fringes are recorded. Therefore, even if the deviation between the projection direction of the image light 51 and the incident direction of the first incident light 41 becomes relatively large, it is possible to secure color reproducibility of the displayed image.

Further, the first incident light 41 is increased in intensity compared with the second incident light 42. Due to this, the interference fringes recorded have a higher efficiency of diffraction of-the image light 51 incident from a slanted direction to the approximate front direction. Furthermore, the second incident light 42 is emitted to the first dispersion plate 3 as nondivergent light. Due to this, it is possible to obtain a hologram screen 1 diffracting image light 51 at an extremely high efficiency to the front direction.

As explained above, according to Example 1, it is possible to provide a method for fabrication of a hologram screen able to give a hologram screen with little luminance irregularity and a high luminance.

### EXAMPLE 2

Example 2 is an example of the second incident light 42 striking the first dispersion plate 3 as divergent light as shown in FIG. 4. As shown in FIG. 4, the first dispersion plate 3 is stacked over the photosensitive layer 2, then the second dispersion plate 32 is arranged at a position in front of the first dispersion plate 3. The entire surface of the second dispersion plate 32 is struck by laser light 421 from the side opposite to the photosensitive layer 2 and the first dispersion plate 3.

Due to this, the laser light 421 disperses and passes through the second dispersion plate 32 to become the divergent light of the second incident light 42 which then strikes the first dispersion plate 3. Further, the first incident light 41 is emitted directly to the first dispersion plate 3 in the same way as in Example 1. As the second dispersion plate 32, a sheet of #1000 double-surface frosted glass is used. The rest of the configuration is similar to that of Example 1.

In this case, the divergent light of the second incident light 42 is further dispersed at the first dispersion plate 3 and strikes the photosensitive layer 2. Therefore, it strikes the photosensitive layer 2 scattered more than the divergent light 451 of the first incident light 41 (see FIG. 2). Therefore, interference fringes diffracting the image light to the line-of-sight direction of the observer E at the front are sufficiently recorded over the entire surface of the photosensitive layer 2 and the luminance irregularity can be reduced even more. Otherwise, there are similar actions and effects as in Example 1.

### EXAMPLE 3

Example 3, as shown in FIG. 5 to FIG. 11, is an example of a method for fabrication of a hologram screen shown in Example 2 (FIG. 4) wherein the degree of dispersion of the first dispersion plate 3 is changed. That is, various characteristics of a hologram screen are measured when making the dispersion angle 0°, ±0.4°, ±1°, ±1.5°, ±2°, ±3°, ±4.50°, and ±12°.

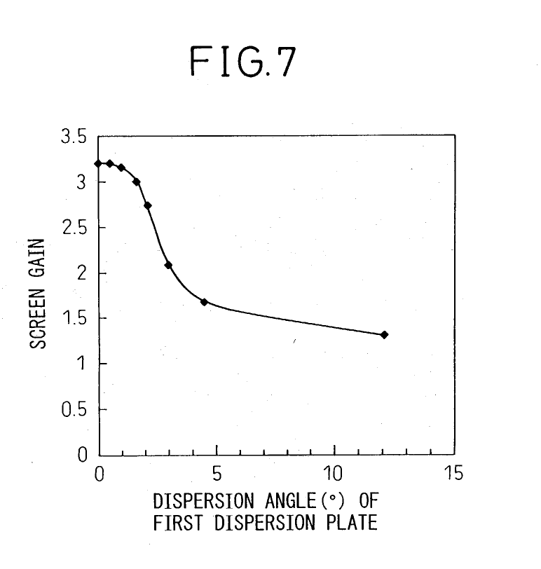

First, as shown in FIG. 7, the relationship between the degree of dispersion of the first dispersion plate 3 (dispersion angle θB) and the screen gain at the obtained hologram screen was measured. On the other hand, the degree of dispersion of the second dispersion plate 32 was fixed and a sheet of #1000 double-surface frosted glass giving a dispersion angle of ±45° was used.

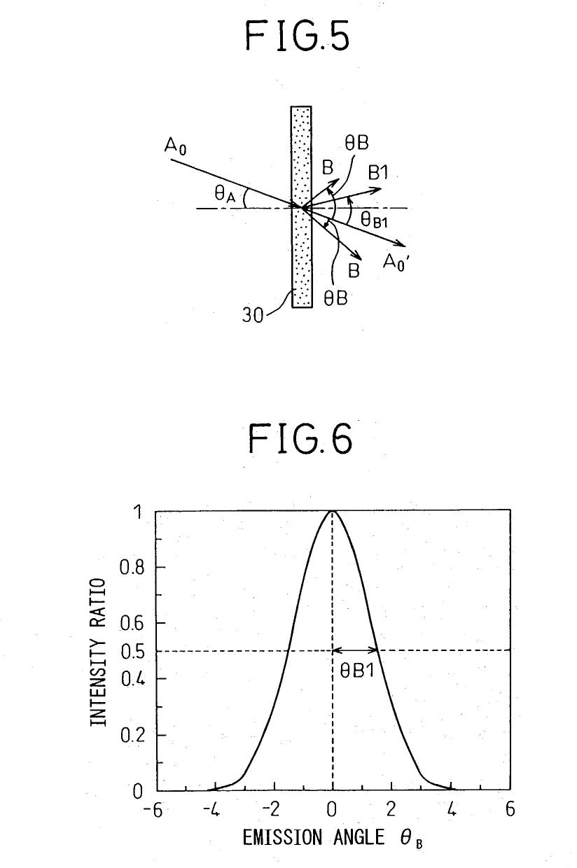

The above dispersion angle was a value defined by the following method of measurement. That is, as shown in FIG. 5, when a laser beam A0 having a wavelength used for exposing a photosensitive layer is emitted from behind the dispersion plate 30 at the same angle θA as the incident angle to the dispersion plate 30 at the time of exposing a photosensitive layer, transmitted light A0′ passing through it as it is by the same angle as the incident angle and a large number of rays of divergent light B having angles relative to the transmitted light A0′ are produced. The distribution of intensity is as shown in FIG. 6. In FIG. 6, the ordinate shows the ratio of intensity of the divergent light with respect to the intensity of the transmitted light A0′, while the abscissa is the angle θB of the divergent light with the transmitted light A0′. Further, the angle θB1 formed by the divergent light B1 giving a ratio of intensity of 0.5 relative to the transmitted light A0′ is made the dispersion angle. Note that FIG. 6 shows the distribution of intensity of a dispersion plate having a dispersion angle of ±1.5°.

When measuring the dispersion angle of the second dispersion plate 32, the incident angle of the incident light A0 is aligned with the vertically incident laser light 421. When measuring the dispersion angle of the first dispersion plate 3, the incident angle of the incident light A0 is matched with the first incident light 41 striking the center of the first dispersion plate 3 (see FIG. 4).

Note that with frosted glass or the like where the dispersion angle does not depend much on the incident angle, the dispersion angle is substantially equal both when measured by perpendicular incidence and measured by slanted incidence. In Example 3, the angle of incident light 41 to the center of the first dispersion plate 3 was made 30°, so the dispersion angle of the first dispersion plate 3 was made the angle relative to incident light A0 of the incident angle 30°.

FIG. 7 is a view plotting the efficiency of the hologram screen, that is, the “screen gain”, on the ordinate and the dispersion angle of the first dispersion plate 3 used on the abscissa. The point of the dispersion angle 0° is the value of the screen gain of a conventional hologram screen not using the first dispersion plate 3. A dispersion plate having a dispersion angle of ±1.5° is called “non-glare glass”. It is glass formed with gentle relief on its surface by using hydrofluoric acid to etch the surface. For example, it is used for a cathode ray tube having a dull-finished surface of a TV etc.

The results of finding the dispersion angle of this glass in accordance with the method of measurement shown in FIG. 5 are shown in FIG. 6. That is, the dispersion angle θB is ±1.5°. Further, dispersion plates having dispersion angles of ±3° and ±4.5° were obtained by superposing two and three sheets of the above non-glare glass. A dispersion plate having a dispersion angle of ±12° was obtained from a single sheet of #1000 double-surface frosted glass.

Further, a dispersion plate having a dispersion angle of ±0.4° was obtained by laminating an anti-glare (AG) film having a haze ratio of about 5% on glass, a dispersion plate having a dispersion angle of ±1° was obtained by laminating an AG film having a haze ratio of about 10% on glass, and a dispersion plate having a dispersion angle of ±2° was obtained by superposing an AG film having a haze ratio of about 5% laminated on glass and a sheet of non-glare glass having a dispersion angle of ±1.5°. As stated above, an “AG film” means “anti-glare film”. “Anti-glare” has the same meaning as the “non-glare” of the above “non-glare glass”. This time, an AG film made by Lintec Corporation was used.

As will be understood from FIG. 7, if using the first dispersion plate 3 having a dispersion angle of ±1.5°, the screen gain value is almost the same as that of a conventional hologram screen not using the first dispersion plate 3. Further, if over a dispersion angle of ±2°, the screen gain falls, but even if the dispersion angle is ±3°, it is possible to secure a sufficient screen gain value. If the dispersion angle is over ±3°, however, the screen gain value may become insufficient. Therefore, when stressing the brightness of the hologram screen, it is preferable to use a first dispersion plate 3 having a dispersion angle of not more than ±3° or so. Further, it can be said to be more preferable to use a first dispersion plate 3 having a dispersion angle of not more than ±2°.

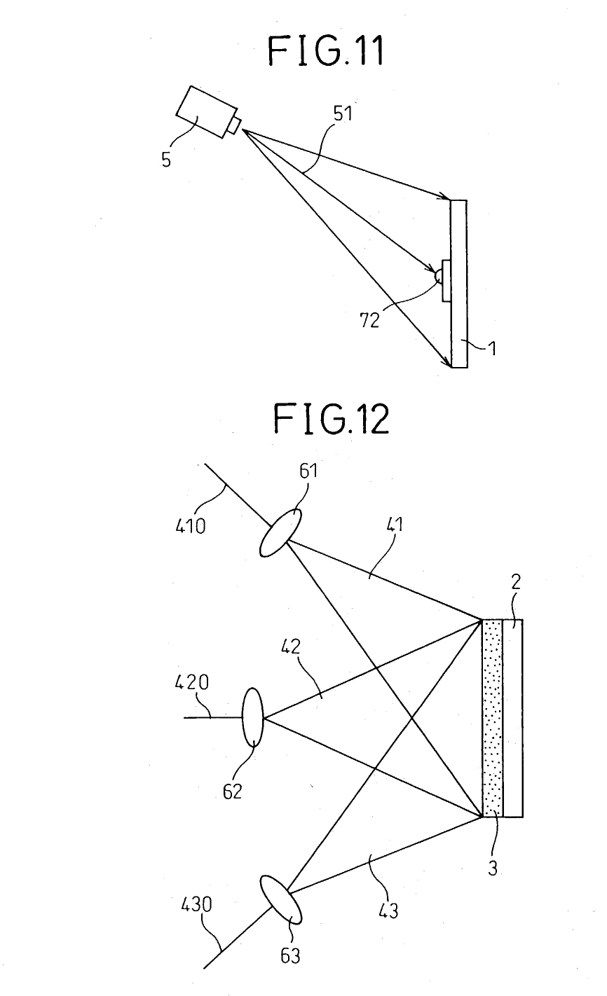

Here, the method of measurement of the screen gain will be explained using FIG. 10 and FIG. 11. First, as shown in FIG. 10, the luminance is measured by a luminance meter 71 arranged in the front of the hologram screen 1 in the state projecting a white screen on the entire surface of the hologram screen 1 from a projector 5. Next, as shown in FIG. 11, an illuminance meter 72 is arranged at the position of measurement by the luminance meter 71 and at the back side of the hologram screen 1 and the illuminance is measured. The screen gain value is calculated from the two data by the following formula (1):

Screen gain=Luminance×π/illuminance (1)

where, the unit of luminance is “cd/m²”, while the unit of illuminance is “lx”.

Note that when measuring the distribution in the plane of the screen, the vertical direction length H of the hologram screen 1 and the distance L between the hologram screen 1 and the luminance meter 71 preferably satisfy the relation of the following formula (2) (see FIG. 10):

H/L=5 (2)

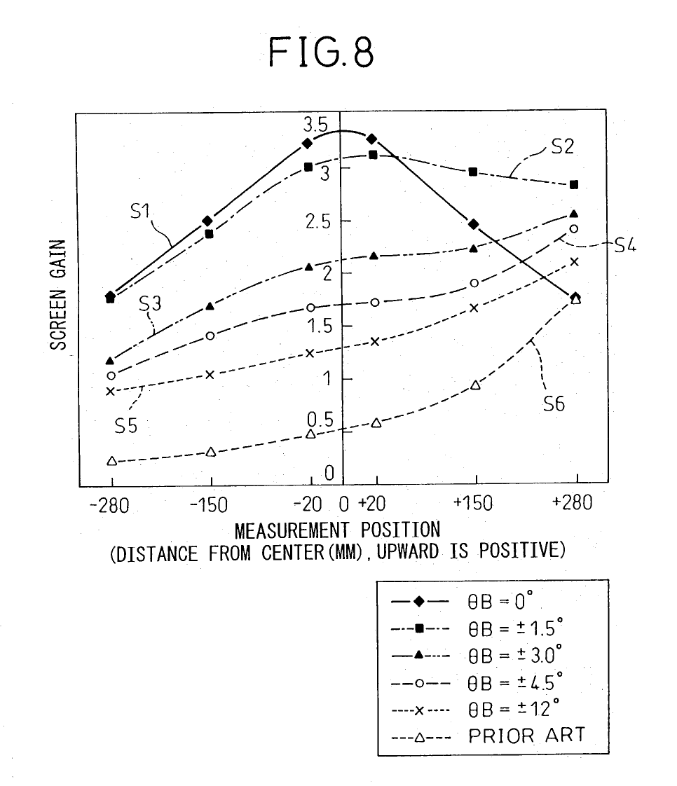

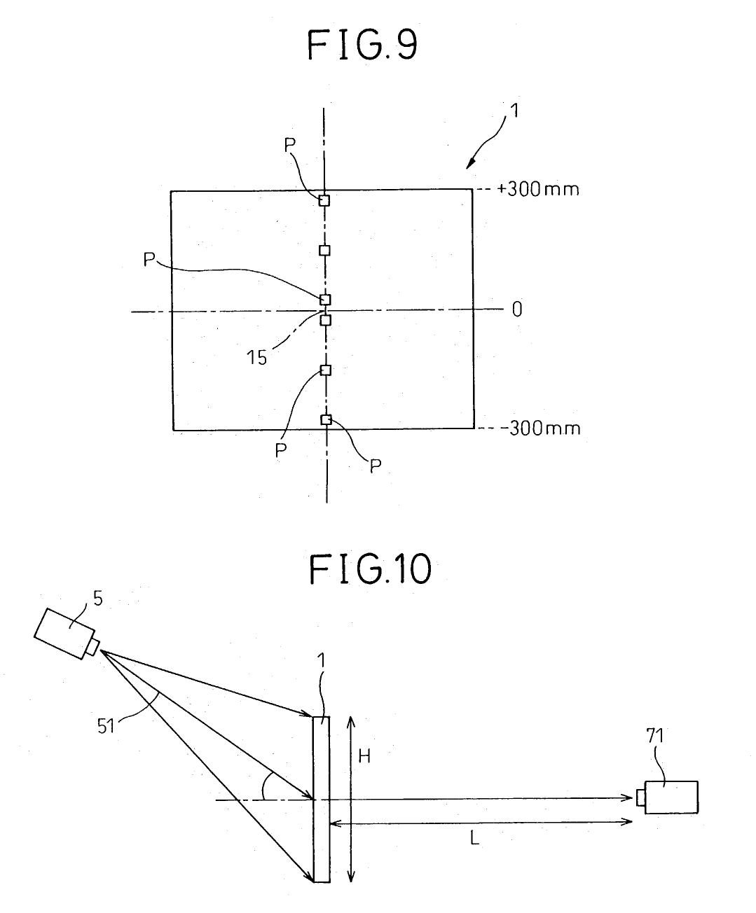

FIG. 8 is a view of the results of measurement of the distribution of the screen gain as an indicator of the luminance irregularity for five types of samples among samples of the same hologram screen 1. The five types of samples were fabricated using first dispersion plates 3 having dispersion angles of 0°, ±1.5°, ±3°, ±4.5°, and ±12°. The measurement points P, as shown in FIG. 9, are made the positions 20 mm, 150 mm, and 280 mm above and below the center 15 of the hologram screens 1. Further, the size of the hologram screen 1 was made 800 mm×600 mm.

In FIG. 8, the curves S1, S2, S3, S4, and S5 show the distributions of luminance of hologram screens 1 fabricated using first dispersion plates 3 having dispersion angles of 0°, ±1.5°, ±3°, ±4.5°, and ±12°. Curve S6 shows the distribution of luminance of a hologram screen fabricated by the conventional photography method shown in FIG. 27. Note that the case where the dispersion angle of the first dispersion plate 3 is 0° indicates the case of exposure without using a dispersion plate. In FIG. 8, the flatter the curve, the less than luminance irregularity indicated.

As will be understood from FIG. 8, if the first dispersion plate 3 is not used (corresponding to dispersion angle of 0°), luminance irregularity arises, but by using the first dispersion plate 3, even if the dispersion angle is ±1.5°, the luminance irregularity is greatly reduced (curves S2 to S5). It will be understood that the luminance irregularity is reduced and the screen gain is improved even compared with the case of fabrication by a conventional method (curve S6).

Further, as the dispersion angle becomes larger, the luminance irregularity is further reduced. With a sample fabricated using a first dispersion plate 3 having a dispersion angle of ±12°, the luminance irregularity at the actual image was so good as to be almost unnoticeable. However, as shown by the curve S5 of FIG. 8, the brightness itself falls, so when stressing the brightness, it is preferable to reduce the dispersion angle, that is, to make the dispersion angle not more than ±3°, more preferably not more than ±2°.

On the other hand, if the dispersion angle of the first dispersion plate 3 is more than ±0.5°, while an effect is obtained of improvement of the luminance at the ends of the hologram screen, there are some cases where the hologram screen is judged as insufficient in terms of luminance irregularity, but if the dispersion angle is more than ±1°, the luminance irregularity is reduced more and the drop in luminance of the center part is just slight, so this is more preferable.

From the results of Example 3, it is preferable to make the first dispersion plate 3 one with a dispersion angle of ±0.5° to ±3°, more preferably one of ±1° to ±2°. Further, it was visually confirmed that none of the above samples exhibited any image loss.

### EXAMPLE 4

Example 4 is an example of emitting third incident light 43 from the first dispersion plate 3 side from a direction different from the first incident light 41 and second incident light 42. The first incident light 41 and second incident light 42 are emitted to the first dispersion plate 3 in the same way as in Example 1.

In addition, the third incident light 43 is emitted from a direction different from the first incident light 41 and second incident light 42. That is, laser light 430 is emitted to the objective lens 63 arranged at a slanted direction relative to the photosensitive layer 2 and first dispersion plate 3 to form the divergent light. Due to this, the above third incident light 43 is obtained and is emitted to the first dispersion plate 3. The rest of the configuration is similar to that of Example 1.

In this case as well, it is possible to broaden the scatter range of the divergent light due to the second incident light 42 and third incident light 43 compared with the divergent light due to the first incident light 41 and emit it to the photosensitive layer 2. Therefore, for the same reasons as in Example 2, it is possible to reduce the luminance irregularity even more. Otherwise, the action and effect are similar to those of Example 1.

### EXAMPLE 5

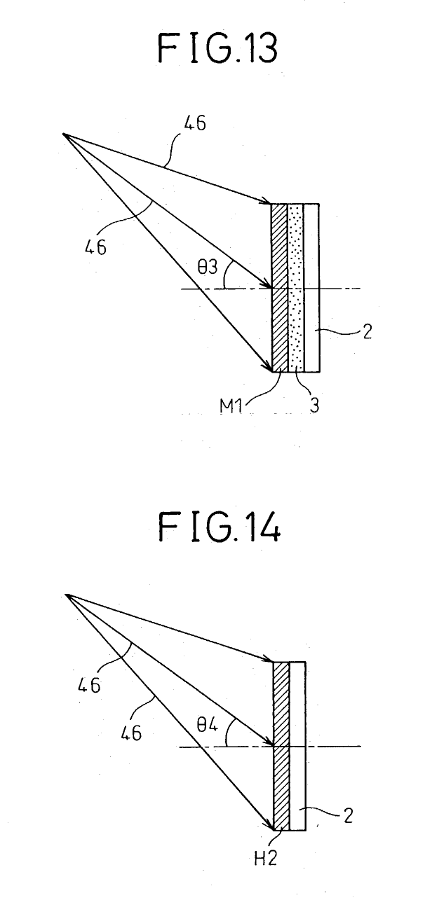

Example 5 is an example of a method for fabrication of a hologram screen 1 by superposing a master hologram M1 recorded with a second dispersion plate in advance behind the first dispersion plate 3 as shown in FIG. 13 instead of arranging the second dispersion plate 32 behind the first dispersion plate 3 in Example 2 (FIG. 4). As the master hologram M1, it is possible to fabricate a hologram by an exposure optical system minus the first dispersion plate 3 in FIG. 4 for example.

In this example, a hologram fabricated using the related art disclosed in Japanese Unexamined Patent Publication (Kokai) No. 11-102153 was used as the master hologram M2. In the photographic optical system of this hologram (FIG. 34), mirrors 81 to 84 are arranged around the dispersion plate 93. Only the mirror 82 is made shorter for emitting the reference light 46 to the photosensitive layer 92.

In this example, a hologram screen was fabricated by exposure while superposing the master hologram M1 fabricated by the above optical system and the first dispersion plate 3 having a dispersion angle of ±1.5° in Example 3 as shown in FIG. 13 in the order of the master hologram M1, the first dispersion plate 3, and the photosensitive layer 2 from the incident side of the reference light. By fabrication in this way, it was possible to completely eliminate the image loss which had occurred in a hologram screen fabricated by the related art (FIG. 34) disclosed in Japanese Unexamined Patent Publication (Kokai) No. 11-102153.

In this example, there is one more advantage. That is, it is possible to fabricate a hologram screen without image loss by just exposure while superposing one more first dispersion plate 3 without remaking the hologram of the related art. Even if using the hologram of the related art (Japanese Unexamined Patent Publication (Kokai) No. 11-102153) as the master hologram and constructing a mass production line by the method of copying, if using Example 5, it is possible to modify this mass production line, without completely overhauling it, so as to immediately mass produce hologram screens without image loss. Otherwise, the action and effect are similar to those of Example 5.

Note that in Example 5 as well, in the same way as Example 4, the dispersion angle of the first dispersion plate 3 is preferably ±0.5° to ±3°. This enables fabrication of a hologram screen with extremely little luminance irregularity and high luminance.

Further, in this example, it is also possible to switch the order of the master hologram M1 and the first dispersion plate 3 and arrange the components in the order of the first dispersion plate 3, master hologram M1, and photosensitive layer 2 for exposure. Even with this, when the dispersion angle of the first dispersion plate 3 is a small one of ±0.5° to ±3°, the characteristics of the hologram screen obtained become substantially the same.

### EXAMPLE 6

Example 6 is an example of the method for fabrication of a hologram screen by using a hologram fabricated by the method of Example 5 as a new master hologram (hereinafter called a “secondary master hologram M2”) and copying it by a so-called single luminous flux method. By using this example, if there is a single master hologram M1 (hereinafter called the “primary master hologram”), it is possible to fabricate a large number of secondary master holograms of substantially the same characteristics and mass produce hologram screens with stable characteristics and quality.

The incident angle θ4 of the reference light at this time is preferably substantially the same as the incident angle θ3 of the reference light to the master hologram M1 in FIG. 13. That is, if |θ4−θ3|≦0.5°, it is possible to fabricate hologram screens of substantially the same characteristics. Otherwise, the action and effect are similar to those of Example 5.

### EXAMPLE 7

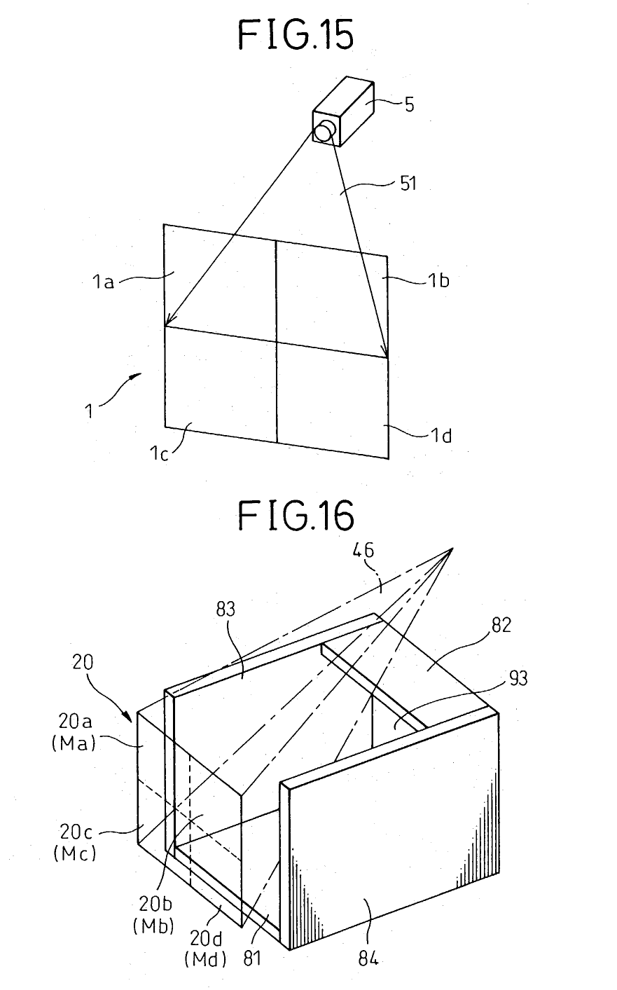

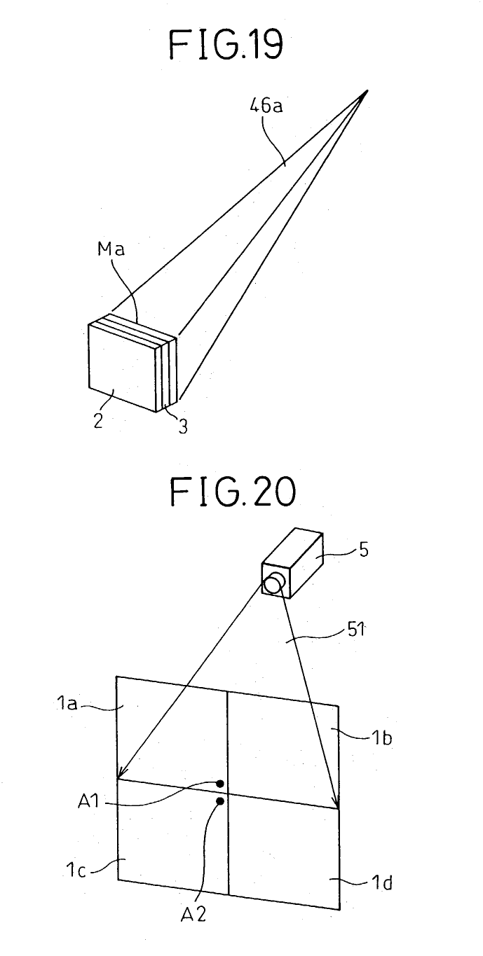

Example 7 is an example of application of the method of Example 5 to the “method for fabrication of a hologram screen by dividing and individually fabricating holograms, then piecing them together” disclosed in Japanese Unexamined Patent Publication (Kokai) No. 11-102153 as shown in FIG. 15 to FIG. 24. That is, in fabricating the master hologram M1 shown in Example 5, as shown in FIG. 16 to FIG. 18, an object light (not shown) and reference light 46 are emitted individually to the plurality of divided master holograms Ma, Mb, Mc, and Md to expose them. Then, as shown in FIG. 19, the plurality of divided master holograms Ma, Mb, Mc, and Md are used to fabricate a plurality of divided holograms 1a, 1b, 1c, and 1d individually, then, as shown in FIG. 15, the plurality of divided holograms 1a, 1b, 1c, and 1d are pieced together so as to have a two-dimensional spread to obtain the hologram screen 1.

In this example, in fabricating a hologram screen 1 of a four-part configuration (divided holograms 1a, 1b, 1c, and 1d) as shown in FIG. 15, four master holograms (divided master holograms Ma, Mb, Mc, and Md) are fabricated (FIG. 16) by a similar method as the conventional method (FIG. 34) shown in Japanese Unexamined Patent Publication (Kokai) No. 11-102153. Next, first dispersion plates 3 having dispersion angles of ±1.5° are stacked on the holograms Ma to Md and exposed (FIG. 19) by a similar configuration as the configuration shown in Example 5 (FIG. 13).

Four divided master holograms (Ma, Mb, Mc, and Md) are necessary, but there need be only one first dispersion plate 3 stacked. Further, the incident angle of the reference light is an angle different for each divided master hologram. As a comparative example, a hologram screen was fabricated without superposing dispersion plates on the same divided master holograms, that is, by copying holograms by the configuration of FIG. 19 minus the first dispersion plates 3 and piecing them together.

The method for fabrication of the hologram screen 1 of Example 7 will be explained in detail next using FIG. 16 to FIG. 19. The hologram screen projection optical system shown in FIG. 16 arranges mirrors 81 to 84 around a dispersion plate 93 larger than the hologram screen of a size of 800 mm×600 mm desired to be fabricated and emits the reference light 46 at the center of the photosensitive layer 20 at an incident angle of 30° and an incident distance of 1700 mm. Further, the photosensitive layer 20 is divided into four pieces (20a, 20b, 20c, and 20d) which are then individually photographed.

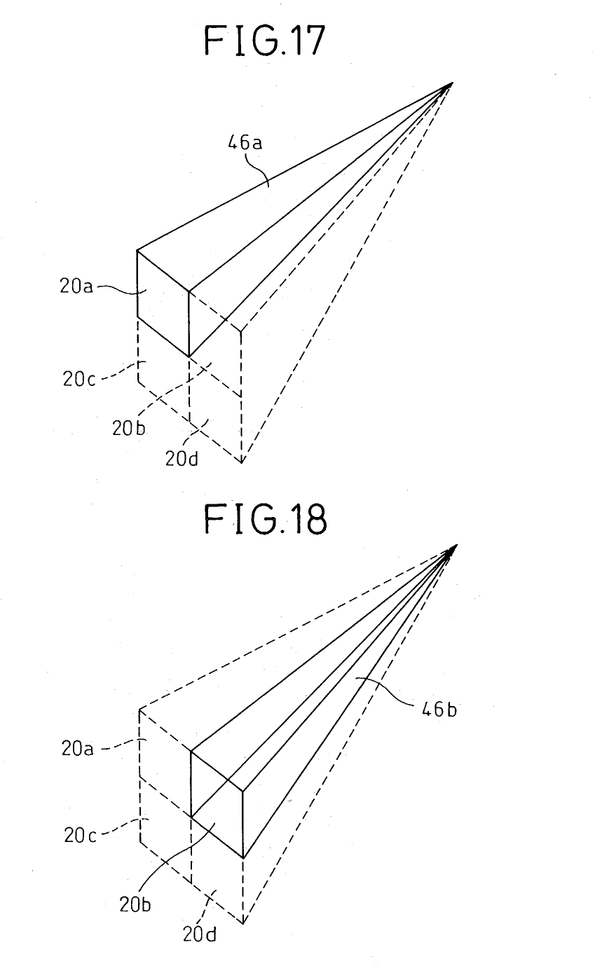

That is, when fabricating the divided hologram 1a shown in FIG. 15 by the method of this example, as shown in FIG. 17, a photosensitive layer 20a of the same size is arranged at the position of the divided hologram 1a and a reference light 46a is emitted. That is, in the reference light 46, just the portion of the reference light 46a required for illumination of the entire surface of the portion of the divided photosensitive layer 20a is emitted. Note that in FIG. 17 and FIG. 18, the illustration of the dispersion plate 93 and mirrors 81 to 84 (see FIG. 16) is omitted. The thus fabricated hologram is stacked over the photosensitive layer 2 and the first dispersion plate 3 as shown in FIG. 19 as the divided master hologram Ma and the reference light 46a is used for exposure to obtain the divided hologram 1a.

When fabricating the divided hologram 1b shown in FIG. 15, as shown in FIG. 18, the reference light 46b is used to expose the photosensitive layer 20b by a similar optical system (FIG. 16) as the above and fabricate the divided master hologram Mb. This divided master hologram Mb is then stacked on the first dispersion plate 3 and the photosensitive layer 2 exposed in the same way as above so as to obtain the divided hologram 1b. As clear from FIG. 18, the reference light 46b forms part of the reference light 46, but the incident angles to the photosensitive layers 20a and 20b differ.

Further, in the same way as when fabricating the divided holograms 1c and 1d shown in FIG. 15, reference lights 46c and 46d are emitted to the photosensitive layers 20c and 20d by the above optical system (FIG. 16) to expose them and fabricate the divided master holograms Mc and Md. These are stacked on the first dispersion plate 3 and the photosensitive layer 2 exposed so as to fabricate the divided holograms 1c and 1d. The fabricated divided holograms 1a, 1b, 1c, and 1d, as shown in FIG. 15, are pieced together to give a two-dimensional spread and thereby obtain the hologram screen 1.

In this example, a dispersion plate having a dispersion angle of ±1.5° in Example 3 was used as the first dispersion plate 3. Further, for the second dispersion plate 93, a stack of four sheets of #1000 double-surface frosted glass giving a dispersion angle of ±45° was used. For the laser used for fabrication of the holograms, an argon laser (wavelength 514 nm) was used, while for the photosensitive layer, HRF-600 made by Dupont was used. The hologram screen of the comparative example was obtained by directly copying the divided master holograms Ma, Mb, Mc, and Md obtained in the same way on to a photosensitive layer without using a dispersion plate and then piecing them together.

The differences in the “brightness” and “color shade” at seam portions at the hologram screen of the example of the invention and comparative example obtained were measured. That is, the values of the differences of the “brightness” and “color shade” at the positions A1 and A2 (FIG. 20) where the difference was most felt at the seam portion of the hologram screen of the comparative example fabricated and the values at the same points A1 and A2 of the hologram screen of the example of the invention were measured and calculated. These values are shown in Table 1.

Note that the measurement was performed as shown in FIG. 20 by projecting image light 51 of a white image from the projector 5 on each hologram screen.

TABLE 1

| | Example of | Comparative |
|---|---|---|
| | invention | example |
| “Brightness” difference ΔSG | 0.12 | 0.30 |
| “Color shade” difference Δu ′v′ | 0.003 | 0.010 |

The “brightness” difference ΔSG is calculated by the following formula (3) after measuring the screen gain values SG1 and SG2 at the two points A1 and A2 (FIG. 20) adjoining each other across the seam:

ΔSG=|SG1−SG2|/{(SG1+SG2)/2} (3)

The “color shade” difference Δu′v′ was calculated by the following formula (4) from the chromaticity values (u1′, v1′) and (u2′, v2′) at the above two points A1 and A2:

Δu′v′={(u1′−u2′)²+(v1′−v2′)²}^{1.2} (4)

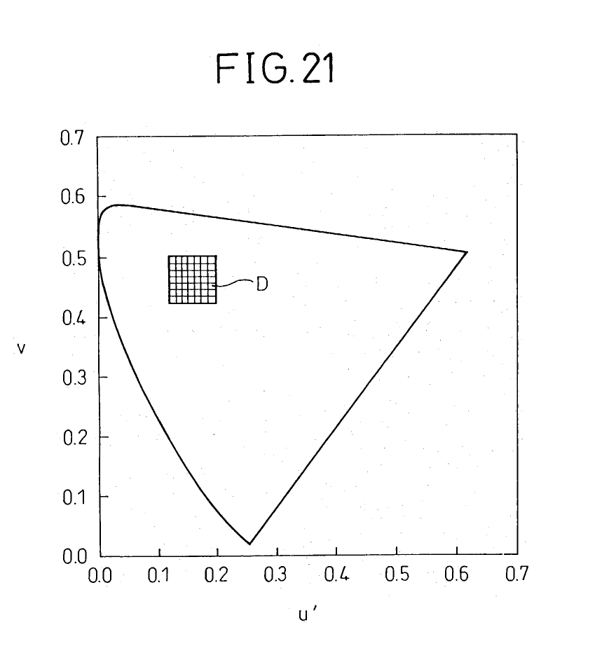

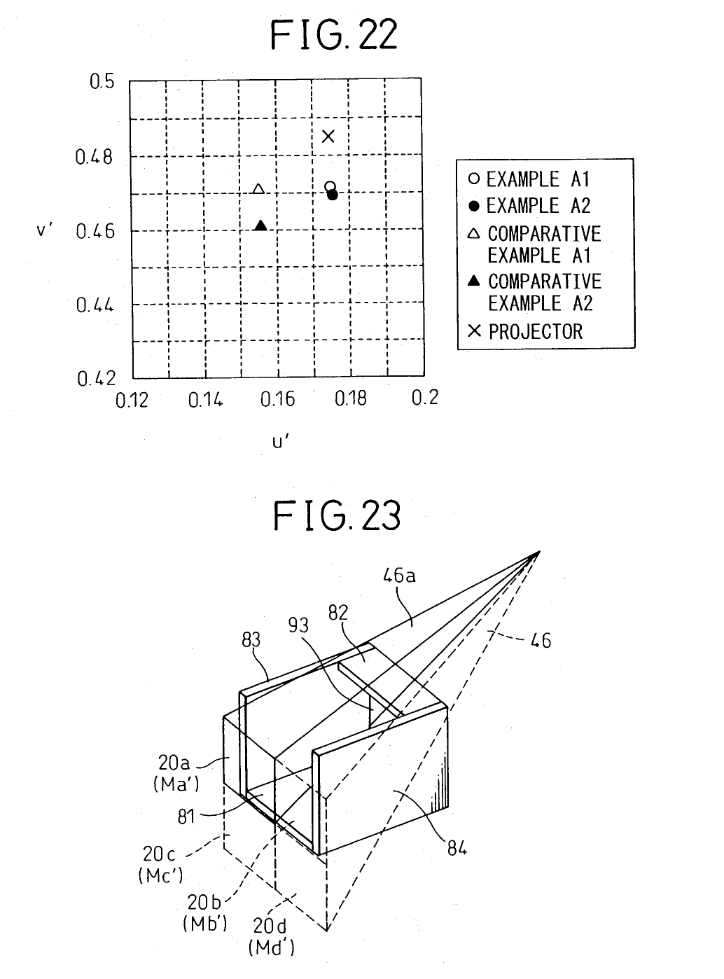

The chromaticity values were measured from positions 3 m distance vertically above the center of the hologram screen using a colori-luminance meter (BM-7 made by Topcon Corporation). The “chromaticity (u′,v′)” is an indicator expressing the “color” as defined by CIE 1976 and is determined by the coordinate values on chromaticity coordinates such as shown in FIG. 21 and FIG. 22. FIG. 22 is an enlargement of the region D at FIG. 21.

As will be understood from Table 1, due to this example, the differences in “brightness” and “color shade” are both greatly reduced to less than half. Further, regarding the color shade, the chromaticities of the different points are shown in the chromaticity coordinate system of FIG. 21 and FIG. 22. The chromaticities at the points A1 and A2 on the hologram screen 1 of this example are shown by “∘” and “●”, while the chromaticities at the points A1 and A2 on the hologram screen of the comparative example are shown by “Δ” and “▴”. In the chromaticity diagram, the chromaticity value of white due to the projector 5 used is also shown as “x”.

The closer the points “∘” and “●” or “Δ” and “▴” showing the chromaticity values of the adjoining two points A1 and A2, the smaller the color difference, while the closer to the chromaticity value “x” of the projector, the better the color of the projector 5 is reproduced. As will be understood from FIG. 22 and Table 1, by applying this example, the color difference becomes smaller and even the color shade itself becomes closer to the chromaticity value of the image light 51 of the projector 5, so there is also the effect of improvement of the color shade.

The above results will be considered next. Since the divided master holograms are fabricated individually, variation in characteristics inevitably end up occurring between the individual divided master holograms. Therefore, if copying the divided master holograms and piecing together the divided holograms as in the above comparative example, the problem arises that deviation occurs in the brightness and color shade at the seam portions.

To deal with this problem, when copying divided master holograms Ma, Mb, Mc, and Md as in this example, it is possible to reduce the deviation in the brightness and color shade at the seam portions after connection by exposure superposing the first dispersion plate 3 on the divided master holograms Ma, Mb, Mc, and Md by the method shown in Example 5.

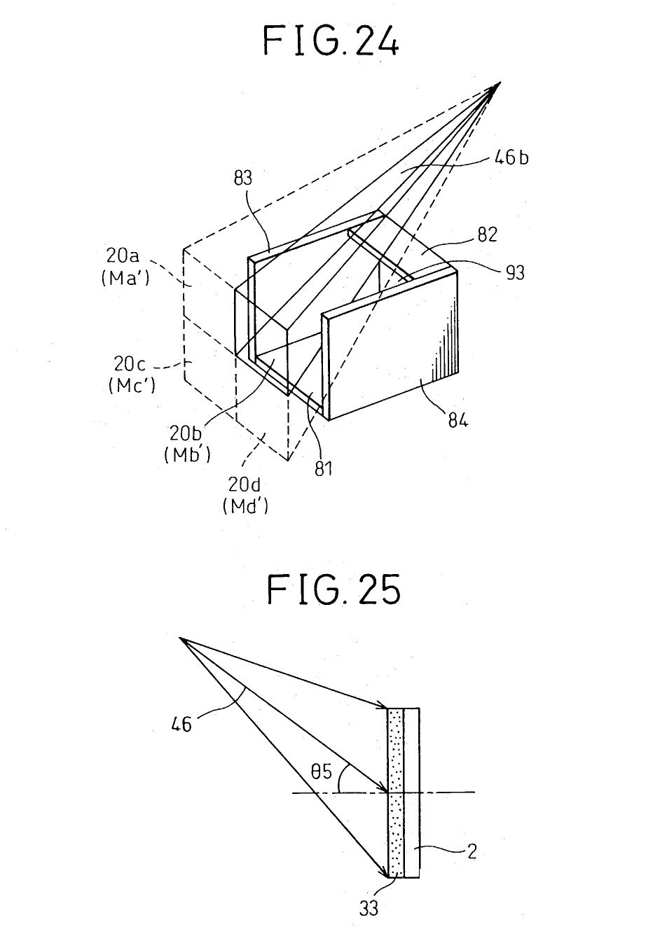

Note that when fabricating by division the hologram screen 1, fabrication is also possible by the method shown in FIG. 23 and FIG. 24. That is, the dispersion plate 93 and mirrors 81 to 84 are reduced in size to match with the size of the holograms after division are used to fabricate the divided master holograms Ma′, Mb′, Mc′, and Md′ corresponding to the divided holograms (1a, 1b, 1c, and 1d). Next, the divided master holograms Ma′, Mb′, Mc′, and Md′ are individually stacked on the photosensitive layer 2 through the first dispersion plate 3 and exposed. In this case, since the photographic optical system of the master hologram is reduced in size, there is the advantage that production is easier.

### EXAMPLE 8

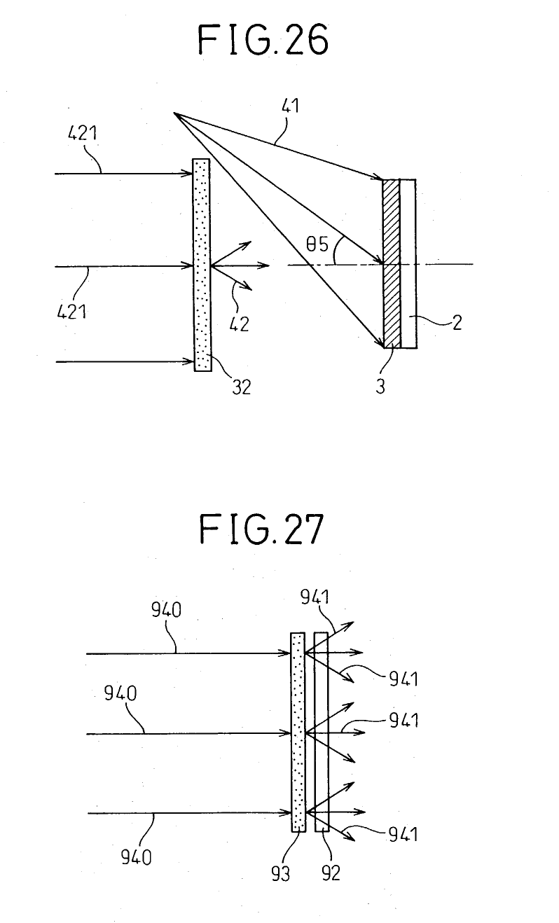

Example 8 is an example of use of a hologram as the first dispersion plate 3 used in Examples 1 to 7 as shown in FIG. 25 and FIG. 26. As this hologram, it is possible to use one obtained by the optical system such as shown in FIG. 25.

That is, this is a single luminous flux photographic optical system which superposes a dispersion plate 33 on a photosensitive layer 2 and emits a reference light 46 from the rear of the dispersion plate 33 at an angle θ5 to obtain the hologram. For the dispersion plate 33 recorded by this method, it is possible to use a dispersion plate having a dispersion angle of ±0.5° to ±3° larger than the dispersion angle considered as preferable in Example 4.

For example, a hologram was fabricated using the dispersion plate having a dispersion angle of ±12° shown in Example 4 as the dispersion plate 33 of FIG. 25. When fabricating a hologram screen by an optical system of FIG. 26, that is, an optical system similar to Example 2 (FIG. 4), using this hologram as the first dispersion plate 3, a hologram screen of a performance similar to the hologram screen 1 fabricated using the first dispersion plate 3 having a dispersion angle of ±3° in Example 3 was obtained. Here, as the second dispersion plate 32, for example, a stack of four sheets of #1000 double-surface frosted glass plates giving a dispersion angle of ±45° was used.

When using an ordinary dispersion plate as the first dispersion plate 3, the incident light is scattered 100%, but if using as the first dispersion plate 3 a dispersion plate recorded on a hologram as in these examples, it is possible to adjust the light passing through it without diffraction by controlling the diffraction efficiency, so it is possible to obtain the same effect as use of a dispersion plate with a small dispersion angle.

While the invention has been described with reference to specific embodiments chosen for purpose of illustration, it should be apparent that numerous modifications could be made thereto by those skilled in the art without departing from the basic concept and scope of the invention.

What is claimed is:

1. A method for fabrication of a hologram screen for displaying an image by diffracting and scattering image light projected from a slanted direction, comprising,
superposing a first dispersion plate on a photosensitive layer, emitting nondivergent light of the first incident light from the first dispersion plate side, emitting second incident light from the first dispersion plate side, and causing rays of divergent light obtained by dispersion and transmission of the first incident light and second incident light through the first dispersion plate to interfere on the photosensitive layer so as to record interference fringes on the photosensitive layer and thereby fabricate a hologram screen, at which time,
making the incident direction of the first incident light relative to the photosensitive layer substantially match the projection direction of the image light relative to the hologram screen and
making the incident direction of the second incident light relative to the photosensitive layer the approximate front direction.

2. A method for fabrication of a hologram screen as set forth in claim 1, wherein said second incident light is made to strike said first dispersion plate as nondivergent light.

3. A method for fabrication of a hologram screen as set forth in claim 1, wherein said second incident light is made to strike said first dispersion plate as divergent light.

4. A method for fabrication of a hologram screen as set forth in claim 3, wherein said second incident light is divergent light obtained by passage through a second dispersion plate having a dispersion angle of ±10° to ±60°.

5. A method for fabrication of a hologram screen as set forth in claim 3, wherein said first dispersion plate has a dispersion angle of ±0.5° to ±3°.

6. A method for fabrication of a hologram screen as set forth in claim 3, wherein said first dispersion plate is a hologram recording a dispersion plate.

7. A method for fabrication of a hologram screen as set forth in claim 1, wherein third incident light is emitted from said first dispersion plate side from a direction different from said first incident light and second incident light.

8. A method for fabrication of a hologram screen for displaying an image by diffracting and scattering image light projected from a slanted direction, comprising,
successively superposing a photosensitive layer, a first dispersion plate, and a master hologram recording a second dispersion plate, emitting nondivergent light of the reference light, to said master hologram from an opposite side of said photosensitive layer and
making divergent light comprised of said reference light passed through said master hologram and dispersed by said first dispersion plate and divergent light produced by reproduction of said second dispersion plate from said master hologram by said reference light interfere with each other on said photosensitive layer so as to record interference fringes on said photosensitive layer and fabricate said hologram screen, at which time,
making the incident direction of the reference light relative to the photosensitive layer substantially match the projection direction of the image light relative to the hologram screen and
making the divergent light diffracted and passing through the master hologram disperse and strike the photosensitive layer centered on the approximate front direction.

9. A method for fabrication of a hologram screen as set forth in claim 8, wherein said second dispersion plate recorded on said master hologram has a dispersion angle of ±10° to ±60°.

10. A method for fabrication of a hologram screen as set forth in claim 8, wherein said first dispersion plate has a dispersion angle of ±0.5° to ±3°.

11. A method for fabrication of a hologram screen as set forth in claim 8, wherein said first dispersion plate is a hologram recording a dispersion plate.

12. A method for fabrication of a hologram screen as set forth in claim 8, wherein said master hologram is recorded with a second dispersion plate provided with mirrors substantially perpendicularly at its four sides.

13. A method for fabrication of a hologram screen as set forth in claim 8, wherein the incident angle of said reference light has a difference with the reference light incidence angle when fabricating said master hologram of within ±5°.

14. A method for fabrication of a hologram screen as set forth in claim 8, wherein said master hologram is comprised of a plurality of divided master holograms, the divided master holograms are individually fabricated by emitting an object light and reference light to the photosensitive layer to expose it, said plurality of divided master holograms are used to individually fabricate a plurality of divided holograms, then the plurality of divided holograms are pieced together so as to have a two-dimensional spread to obtain a hologram screen.

15. A method for fabrication of a hologram screen for displaying an image by diffracting and scattering image light projected from a slanted direction, comprising,
successively superposing a photosensitive layer, a first dispersion plate, and a primary master hologram recording a second dispersion plate, emitting nondivergent light of the reference light from an opposite side of said photosensitive layer relative to said primary master hologram and
making divergent light comprised of said reference light passed through said primary master hologram and dispersed by said first dispersion plate and divergent light produced by reproduction of said second dispersion plate from said primary master hologram by said reference light interfere with each other on said photosensitive layer so as to record interference fringes on said photosensitive layer and fabricate a secondary master hologram, then
superposing on said secondary master hologram a photosensitive layer on the surface at the opposite side as the incident surface of said reference light and emit a reference light of the same state as the reference light so as to copy said secondary master hologram and fabricate a hologram screen, at which time,
making the incident direction of the reference light relative to the photosensitive layer substantially match the projection direction of the image light relative to the hologram screen and
making the divergent light diffracted and passing through the primary master hologram disperse and strike the photosensitive layer centered on the approximate front direction.

16. A method for fabrication of a hologram screen as set forth in claim 8, wherein said primary master hologram and secondary master hologram are comprised of pluralities of divided primary master holograms and divided secondary master holograms, the divided primary master holograms are individually fabricated by emitting an object light and reference light to the photosensitive layer to expose it, said plurality of divided primary master holograms are used to individually fabricate a plurality of divided secondary master holograms, the divided secondary master holograms are used to individually reproduce their information on a plurality of divided holograms, then the plurality of divided holograms are pieced together so as to have a two-dimensional spread to obtain a hologram screen.
